(19) United States
(12) Patent Application Publication
(10) Pub. No.: US 2017/0367542 A1
(43) Pub. Date: Dec. 28, 2017

(54) APPLICATOR DEVICE

(71) Applicant: BarShonia Terrell, Jamaica, NY (US)

(72) Inventor: BarShonia Terrell, Jamaica, NY (US)

(21) Appl. No.: 15/630,790

(22) Filed: Jun. 22, 2017

Related U.S. Application Data
(60) Provisional application No. 62/353,299, filed on Jun. 22, 2016.

(51) Int. Cl. A47K 7/02; A47K 7/03; A61H 23/00

(52) U.S. Cl. CPC A47K 7/028; A61H 23/00; A47K 7/03; A61H 2201/0214; A61H 2201/0207

(57) ABSTRACT

An improved applicator device is an elongated, extendable applicator for applying liquids, gels, or lotions on hard-to-reach areas of the body. The device may have a removable and washable sponge which can also be replaced when worn and have a temperature controlled reservoir within the handle for heating or cooling the lotions along with having vibrating, massage capabilities.

### CROSS-REFERENCE TO RELATED APPLICATION

The present application is related to and claims priority from prior provisional application Ser. No. 62/353,299, filed Jun. 22, 2016 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of applicator devices and more specifically relates to an improved applicator device.

### 2. Description of the Related Art

An applicator is a tool or device used to apply a fluid or semi-fluid substance to a surface. A sponge is a tool or cleaning aid consisting of soft, porous material. Sponges are usually used for cleaning impervious surfaces. They are especially good at absorbing water and water-based solutions. Sponges are commonly made from cellulose wood fibers or foamed plastic polymers. Some natural sponges are still sold, but most are now used either as body or facial sponges (bath sponges) or as tools for sponge painting. Bath sponges help cleanse the skin by scraping away the dead skin and washing away dirt. The three other categories of widely available synthetic sponges are low-density polyether (known as the rainbow packs of non-absorbent sponges), PVA (a highly absorbent material), and polyester. Unfortunately, users may have a hard time reaching certain areas of a body with the conventional sponge or applicator.

Various attempts have been made to solve the above-mentioned problems such as those found in U.S. Pat. No. 20120009002 to Patrick Ping Sun Lo; U.S. Pat. No. 20040208683 to Swanan et al; and U.S. Pat. No. 6,805,682 to Mark C. Campbell. This art is representative of applicator devices. None of the above inventions and patents, taken either singly or in combination, is seen to describe the invention as claimed.

Ideally, a applicator devices should provide thorough application, gentle exfoliation, and a pleasant experience, and yet, would operate reliably and be manufactured at a modest expense. Thus, a need exists for a reliable improved applicator device to avoid the above-mentioned problems.

### BRIEF SUMMARY OF THE INVENTION

In view of the foregoing disadvantages inherent in the known applicator device art, the present invention provides a novel improved applicator device. The general purpose of the present invention, which will be described subsequently in greater detail, is to provide thorough application, gentle exfoliation, and a pleasant experience.

The improved applicator device preferably comprises an elongated handle member formed as a an elongated tube, a sponge member attached to a distal end of the elongated handle member, a reservoir located within the tube at a proximal end that is adapted to retain a liquid substance within, a pump member located within the tube in between the reservoir and the distal end of the elongated handle member that is adapted to pump the liquid substance from the reservoir through the distal end of the elongated handle member and into the sponge member such that a user can apply the liquid substance from the sponge member onto their body while scrubbing their body at the same time.

A heating element is located within the tube in between the reservoir and the distal end of the elongated handle member that is adapted to heat the liquid substance before it reaches the sponge member. A cooling element is located within the tube in between the reservoir and the distal end of the elongated handle member that is adapted to cool the liquid substance before it reaches the sponge member.

A control member is located within the tube in between the reservoir and the distal end of the elongated handle member that is adapted to control the pump member, the heating element, and the cooling element, such that a user can control the temperature of the liquid substance before it reaches the sponge member.

A vibrating member is located within the tube in proximity to the sponge member and is adapted to be controlled by the control member and vibrate the tube member and the sponge member to provide vibrations to the body of the user. The elongated handle member further includes a cup-shaped portion on the distal end thereof adapted to releasably retain the sponge member therein. The sponge member is adapted to be removed from the cup-shaped portion, washed, and replaced with a similar sponge member. A power source is located within the tube and adapted to power the heating element, the cooling element, the pump member, and the vibrating member.

The reservoir includes an input nozzle adapted to allow more of the liquid substances to be injected therein. The elongated handle member includes a removable cap member on the proximal end adapted to allow access to the reservoir and the input nozzle. The elongated handle member is formed from a material chosen from the group of materials consisting of wood and bamboo.

The elongated tube of the elongated handle member may be formed as a telescoping tube member to be extendable in length. The control member may include a dial member for allowing rotatable adjustment of the temperature of the liquid substance before it reaches the sponge member or the control member may include a slide member for allowing linear adjustment of the temperature of the liquid substance before it reaches the sponge member instead of a rotatable adjustment. The control member may also include a slide member thereon for allowing linear adjustment of the amplitude of vibrations of the vibrator member. The elongated handle member is formed as being waterproof and the sponge member may be formed as a loofah sponge.

The present invention holds significant improvements and serves as an improved applicator device. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, improved applicator device constructed and operative according to the teachings of the present invention.

FIG. 1 shows a perspective view illustrating an improved applicator device according to an embodiment of the present invention.

FIG. 2 is a perspective view illustrating an improved applicator device according to an embodiment of the present invention of FIG. 1.

FIG. 3 is a perspective view illustrating improved applicator device according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to an applicator device and more particularly to an improved applicator device as used to improve the thorough application, gentle exfoliation, and a pleasant experience.

Generally speaking, an improved applicator device is an elongated, extendable applicator for applying liquids, gels, or lotions on hard-to-reach areas of the body. The device may have a removable and washable sponge which can also be replaced when worn and have a temperature controlled reservoir within the handle for heating or cooling the lotions along with having vibrating, massage capabilities.

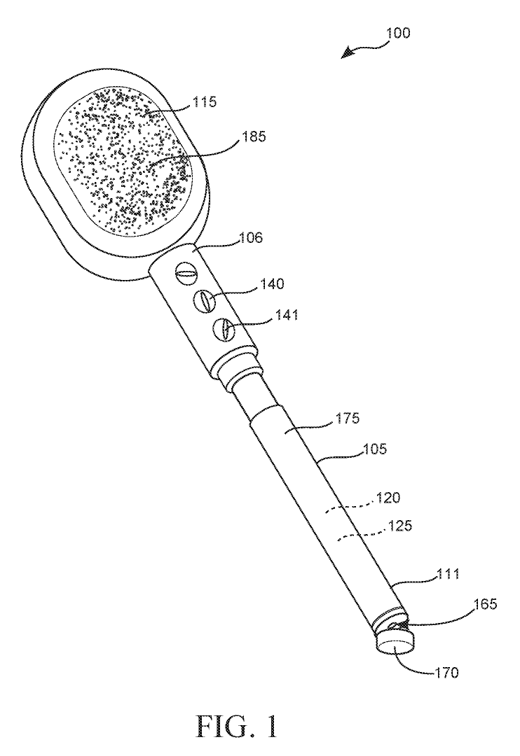

Referring to the drawings by numerals of reference there is shown in FIG. 1, a perspective view illustrating improved applicator device 100 according to an embodiment of the present invention.

Improved applicator device 100 preferably comprises elongated handle member 105 formed as a elongated tube 110, sponge member 115 attached to distal end 106 of elongated handle member 105, reservoir 120 located within elongated tube 110 at proximal end 111 that is adapted to retain liquid substance 125 within, pump member 130 located within elongated tube 110 in between reservoir 120 and distal end 106 of elongated handle member 105 that is adapted to pump liquid substance 125 from reservoir 120 through distal end 106 of elongated handle member 105 and into sponge member 115 such that a user can apply liquid substance 125 from sponge member 115 onto their body while scrubbing their body at the same time.

Heating element 145 is located within elongated tube 110 in between reservoir 120 and distal end 106 of elongated handle member 105 that is adapted to heat liquid substance 125 before it reaches sponge member 115. Cooling element 135 is located within elongated tube 110 in between reservoir 120 and distal end 106 of elongated handle member 105 that is adapted to cool liquid substance 125 before it reaches sponge member 115.

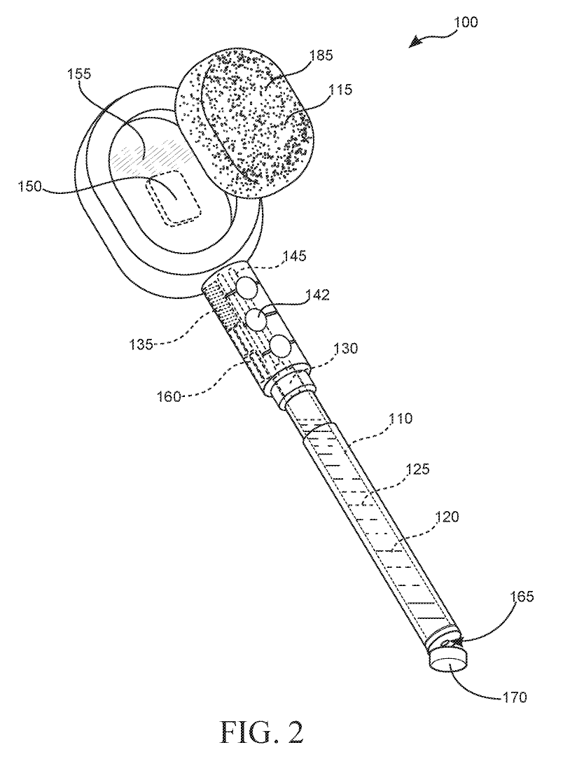

Referring now to FIG. 2, is a perspective view illustrating improved applicator device 100 according to an embodiment of the present invention of FIG. 1.

Control member 140 is located within elongated tube 110 in between reservoir 120 and distal end 106 of elongated handle member 105 that is adapted to control pump member 130, heating element 145, and cooling element 135, such that a user can control the temperature of liquid substance 125 before it reaches sponge member 115.

Vibrating member 150 is located within elongated tube 110 in proximity to sponge member 115 and is adapted to be controlled by control member 140 and vibrate elongated tube 110 and sponge member 115 to provide vibrations to the body of the user. Elongated handle member 105 further includes cup-shaped portion 155 on distal end 106 thereof adapted to releasably retain sponge member 115 therein. Sponge member 115 is adapted to be removed from cup-shaped portion 155, washed, and replaced with a similar sponge member 115. Power source 160 is located within elongated tube 110 and adapted to power heating element 145, cooling element 135, pump member 130, and vibrator member 150.

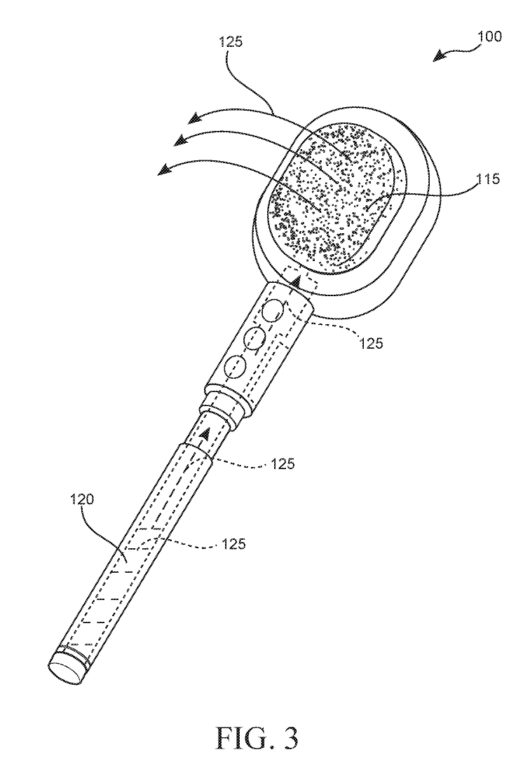

Referring now to FIG. 3, is a perspective view illustrating improved applicator device 100 according to an embodiment of the present invention of FIG. 1.

Reservoir 120 includes input nozzle 165 adapted to allow more of liquid substance 125 to be injected therein. Elongated handle member 105 includes removable cap member 170 on proximal end 111 adapted to allow access to reservoir 120 and input nozzle 165. Elongated handle member 105 is formed from a material chosen from the group of materials consisting of wood and bamboo.

Elongated tube 110 of elongated handle member 105 may be formed as telescoping tube member 175 to be extendable in length. Control member 140 may include dial member 141 for allowing rotatable adjustment of the temperature of liquid substance 125 before it reaches sponge member 115 or control member 140 may include slide member 142 for allowing linear adjustment of the temperature of liquid substance 125 before it reaches sponge member 115 instead of a rotatable adjustment. Control member 140 may also include slide member 142 thereon for allowing linear adjustment of the amplitude of vibrations of vibrating member 150. Elongated handle member 105 is formed as being waterproof and sponge member 115 may be formed as loofah sponge 185.

An improved applicator device 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claim:

1. An improved applicator device comprising:
an elongated handle member;
wherein said elongated handle member is formed as a an elongated tube;
a sponge member;
wherein said sponge member is attached to a distal end of said elongated handle member;
a reservoir;
wherein said reservoir is located within said tube at a proximal end thereof and is adapted to retain a liquid substance therein;
a pump member;
wherein said pump member is located within said tube in between said reservoir and said distal end of said elongated handle member; and
wherein said pump member is adapted to pump said liquid substance from said reservoir, through said distal end of said elongated handle member, and into said sponge member, such that a user can apply said liquid substance from said sponge member onto their body while scrubbing their body at the same time;
a heating element;
wherein said heating element is located within said tube in between said reservoir and said distal end of said elongated handle member; and
wherein said heating element is adapted to heat said liquid substance before it reaches said sponge member;
a cooling element;
wherein said cooling element is located within said tube in between said reservoir and said distal end of said elongated handle member; and
wherein said cooling element is adapted to cool said liquid substance before it reaches said sponge member;
a control member;
wherein said control member is located within said tube in between said reservoir and said distal end of said elongated handle member; and
wherein said control member is adapted to control said pump member; and
wherein said control member is adapted to control said heating element and said cooling element, such that a user can control the temperature of said liquid substance before it reaches said sponge member.

2. The improved applicator device of claim 1, further comprising:
a vibrating member;
wherein said vibrating member is located within said tube in proximity to said sponge member;
wherein said vibrating member is adapted to be controlled by said control member and vibrate said tube member and said sponge member to thereby provide vibrations to said body of said user.

3. The improved applicator device of claim 1, wherein said elongated handle member further includes a cup-shaped portion on said distal end thereof adapted to releasably retain said sponge member therein.

4. The improved applicator device of claim 3, wherein said sponge member is adapted to be removed from said cup-shaped portion, washed, and replaced therein.

5. The improved applicator device of claim 3, wherein said sponge member is adapted to be removed from said cup-shaped portion and replaced by a similar sponge member.

6. The improved applicator device of claim 2, further comprising:
a power source;
wherein said power source is located within said tube and adapted to power said heating element, said cooling element, said pump member, and
said vibrating member.

7. The improved applicator device of claim 1, wherein said reservoir includes an input nozzle adapted to allow more of said liquid substances to be injected therein.

8. The improved applicator device of claim 7, wherein said elongated handle member includes a removable cap member on said proximal end adapted to allow access to said reservoir and said input nozzle.

9. The improved applicator device of claim 1, wherein said elongated handle member is formed from a material chosen from a group of materials consisting of wood and bamboo.

10. The improved applicator device of claim 1, wherein said elongated tube of said elongated handle member is formed as a telescoping tube member to thereby be extendable in length.

11. The improved applicator device of claim 1, wherein said control member includes a dial member thereon for allowing rotatable adjustment of said temperature of said liquid substance before it reaches said sponge member.

12. The improved applicator device of claim 1, wherein said control member includes a slide member thereon for allowing linear adjustment of said temperature of said liquid substance before it reaches said sponge member.

13. The improved applicator device of claim 2, wherein said control member includes a slide member thereon for allowing linear adjustment of the amplitude of vibrations of said vibrator member.

14. The improved applicator device of claim 1, wherein said elongated handle member is formed ad being waterproof.

15. The improved applicator device of claim 1, wherein said sponge member is formed as a loofah sponge.
